(19) United States
(12) Patent Application Publication
(10) Pub. No.: US 2022/0335855 A1
(43) Pub. Date: Oct. 20, 2022

(54) PRE-DRIVING TEST DEVICE

(71) Applicant: TOYOTA JIDOSHA KABUSHIKI KAISHA, Toyota-shi (JP)

(72) Inventors: Tadahiro Kashiwai, Nagoya-shi (JP); Toyokazu Nakashima, Nagoya-shi (JP); Hideo Hasegawa, Nagoya-shi (JP); Kazuya Iwata, Nagoya-shi (JP); Shinichiro Iida, Toyota-shi (JP); Kiyonori Yoshida, Toyota-shi (JP); Yota Sakurai, Nagoya-shi (JP)

(73) Assignee: TOYOTA JIDOSHA KABUSHIKI KAISHA, Toyota-shi (JP)

(21) Appl. No.: 17/689,393

(22) Filed: Mar. 8, 2022

(30) Foreign Application Priority Data
Apr. 15, 2021 (JP) 2021-069319

(51) Int. Cl. G09B 19/16; G06Q 30/02

(52) U.S. Cl. CPC G09B 19/167; G06Q 30/0207

(57) ABSTRACT

A pre-driving test device includes a control unit that calculates a score of a pre-driving test by outputting request data that requests a user for performing a user operation including, as the pre-driving test, a steering wheel operation, an accelerator operation, a brake operation, or an arbitrary combination of the steering wheel operation, the accelerator operation, and the brake operation, after a vehicle is started and before the vehicle starts moving, acquiring vehicle data recorded in the vehicle while the user operation is being performed, and evaluating the user operation based on the vehicle data acquired, and determines whether to give an incentive to the user by comparing the calculated score with a reference score.

### CROSS-REFERENCE TO RELATED APPLICATION

This application claims priority to Japanese Patent Application No. 2021-069319 filed on Apr. 15, 2021, incorporated herein by reference in its entirety.

### BACKGROUND

### 1. Technical Field

The present disclosure relates to a pre-driving test device.

### 2. Description of Related Art

Japanese Unexamined Patent Application Publication No. 2009-245434 (JP 2009-245434 A) discloses a method of notifying a user of a risk level of the user by causing the user to undergo at least one perceptual test. Examples of the tests include a test in which the user tracks a target on a multifunction screen of a vehicle for x seconds while manipulating the steering wheel, and a test that the user depresses a brake pedal of the vehicle when any one sign appears on the screen or a combination meter of instruments.

### SUMMARY

It is conceivable that users do not like vehicles that force the tests as described above. However, when the test is optional, some users may not take the test at all.

An object of the present disclosure is to facilitate implementation of pre-driving tests.

A pre-driving test device according to the present disclosure includes a control unit that calculates a score of a pre-driving test by outputting request data that requests a user for performing a user operation including, as the pre-driving test, a steering wheel operation, an accelerator operation, a brake operation, or an arbitrary combination of the steering wheel operation, the accelerator operation, and the brake operation, after a vehicle is started and before the vehicle starts moving, acquiring vehicle data recorded in the vehicle while the user operation is being performed, and evaluating the user operation based on the vehicle data acquired, and determines whether to give an incentive to the user by comparing the calculated score with a reference score.

According to the present disclosure, implementation of the pre-driving tests is facilitated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a system according to an embodiment of the present disclosure;

FIG. 2 is a diagram showing an example of giving an incentive according to the embodiment of the present disclosure;

FIG. 3 is a block diagram showing a configuration of a pre-driving test device according to the embodiment of the present disclosure; and

FIG. 4 is a flowchart showing an operation of the pre-driving test device according to the embodiment of the present disclosure.

### DETAILED DESCRIPTION OF EMBODIMENTS

Hereinafter, embodiments of the present disclosure will be described below with reference to the drawings.

In each drawing, the same or corresponding portions are denoted by the same reference signs. In the description of each embodiment, description of the same or corresponding components will be appropriately omitted or simplified.

An embodiment of the present disclosure will be described.

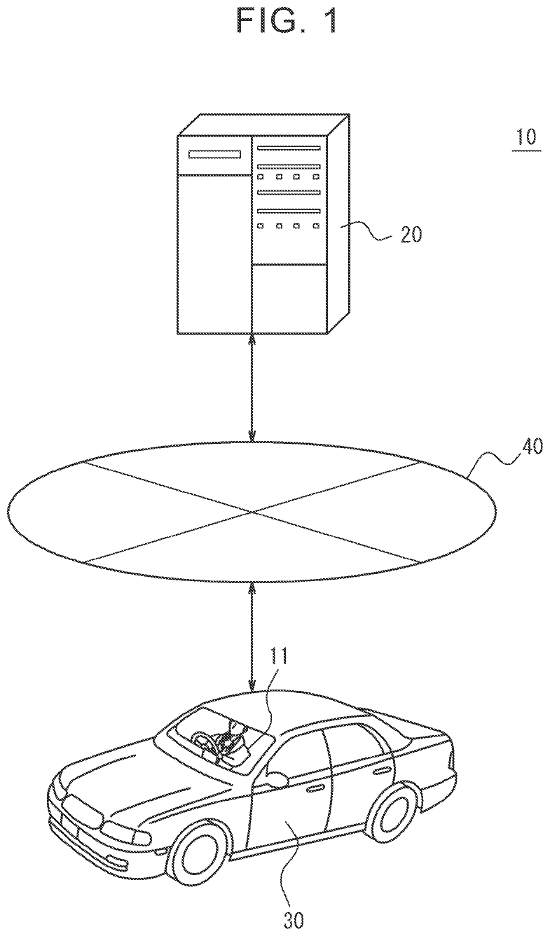

The configuration of a system 10 according to the present embodiment will be described with reference to FIG. 1.

The system 10 according to the present embodiment includes at least one pre-driving test device 20, and at least one vehicle 30. The pre-driving test device 20 can communicate with the vehicles 30 via a network 40.

The pre-driving test device 20 is installed in facilities such as a data center. The pre-driving test device 20 is, for example, a computer such as a server belonging to a cloud computing system or other computing systems.

The vehicle 30 is any type of vehicle, such as a gasoline vehicle, a diesel vehicle, an HEV, a PHEV, a BEV, or an FCEV. The term “HEV” is an abbreviation for “hybrid electric vehicle”. The term “PHEV” is an abbreviation for “plug-in hybrid electric vehicle”. The term “BEV” is an abbreviation for “battery electric vehicle”. The term “FCEV” is an abbreviation for “fuel cell electric vehicle”. The vehicle 30 is driven by a user 11 who is a driver.

The network 40 includes the Internet, at least one WAN, at least one MAN, or any combination thereof. The term “WAN” is an abbreviation for “wide area network”. The term “MAN” is an abbreviation for “metropolitan area network”. The network 40 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation for “local area network”.

The outline of the present embodiment will be described with reference to FIG. 1.

The pre-driving test device 20 outputs request data D1 and acquires vehicle data D2 after the vehicle 30 is started and before the vehicle 30 starts moving. The request data D1 is data that requests the user 11 for performing the user operation as a pre-driving test. The user operation includes steering wheel operation, accelerator operation, brake operation, or any combination thereof. The vehicle data D2 is data recorded by the vehicle 30 while the user operation is being performed. The pre-driving test device 20 calculates a score of the pre-driving test by evaluating the user operation based on the acquired vehicle data D2. The pre-driving test device 20 compares the calculated score with the reference score to determine whether to give the user 11 an incentive.

According to this embodiment, the user 11 can be motivated to take a pre-driving test. Therefore, implementation of the pre-driving tests is facilitated. For example, when the user 11 is an elderly person, an accident caused by the elderly driver can be reduced by implementing a simple appropriateness test before starting driving every time the elderly person is on board the vehicle. The pre-driving test device 20 may recommend the user 11 to stop driving or voluntarily return the driver's license when the user 11 fails the pre-driving test, such as when the score of the pre-driving test does not reach the reference score. Alternatively, the pre-driving test device 20 may control the vehicle 30 as to prohibit movement of the vehicle 30.

The incentive given to the user 11 is, for example, granting of reward points that can be used when the user 11 buys some product or receives some service, raising of the interest rate of the deposit account, or reduction of the commission for investing in securities.

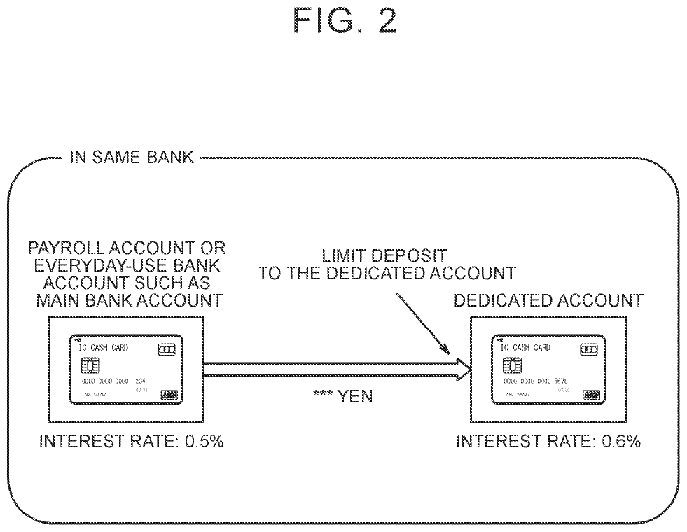

An example of giving an incentive to the user 11 by raising the interest rate of the deposit account will be described with reference to FIG. 2.

In the example of FIG. 2, the preset amount is transferred from the bank account that the user 11 always uses to a dedicated account having a higher interest rate than the bank account the user 11 always uses. However, this applies on condition that the balance of the bank account that the user 11 always uses is equal to or more than a preset amount.

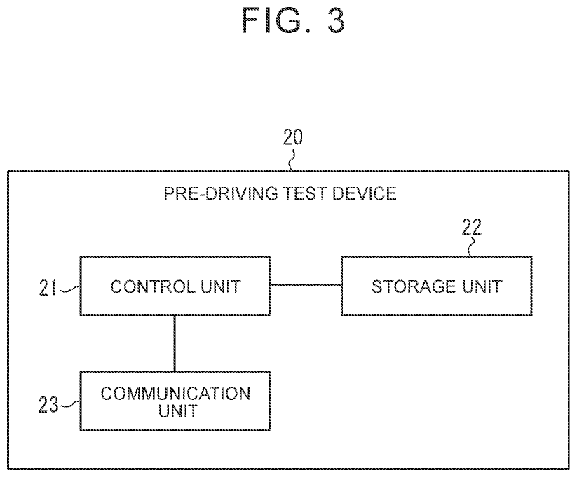

The configuration of the pre-driving test device 20 according to the present embodiment will be described with reference to FIG. 3.

The pre-driving test device 20 includes a control unit 21, a storage unit 22, and a communication unit 23.

The control unit 21 includes at least one processor, at least one programmable circuit, at least one dedicated circuit, or any combination thereof. The processor is a general-purpose processor such as a CPU or GPU, or a dedicated processor specialized for a specific process. The term “CPU” is an abbreviation for “central processing unit”. The term “GPU” is an abbreviation for “graphics processing unit”. The programmable circuit is, for example, an FPGA. The term “FPGA” is an abbreviation for “field-programmable gate array”. The dedicated circuit is, for example, an ASIC. The term “ASIC” is an abbreviation for “application specific integrated circuit”. The control unit 21 executes a process related to an operation of the pre-driving test device 20 while controlling each unit of the pre-driving test device 20.

The storage unit 22 includes at least one semiconductor memory, at least one magnetic memory, at least one optical memory, or any combination thereof. The semiconductor memory is, for example, a RAM or a ROM. The term “RAM” is an abbreviation for “random access memory”. The term “ROM” is an abbreviation for “read-only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read-only memory”. The storage unit 22 functions as, for example, a main storage device, an auxiliary storage device, or a cache memory. The storage unit 22 stores data used for the operation of the pre-driving test device 20 and data acquired through the operation of the pre-driving test device 20.

The communication unit 23 includes at least one communication interface. The communication interface is, for example, a LAN interface. The communication unit 23 receives the data used for the operation of the pre-driving test device 20, and transmits the data acquired through the operation of the pre-driving test device 20.

The function of the pre-driving test device 20 is realized by executing the program according to the present embodiment with the processor serving as the control unit 21. That is, the function of the pre-driving test device 20 is realized by software. The program causes the computer to perform the operation of the pre-driving test device 20 such that the computer functions as the pre-driving test device 20. That is, the computer functions as the pre-driving test device 20 by performing the operation of the pre-driving test device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. The distribution of the program is carried out, for example, by selling, transferring, or renting a portable medium such as an SD card, a DVD, or a CD-ROM in which the program is stored. The term “SD” is an abbreviation for “secure digital”. The term “DVD” is an abbreviation for “digital versatile disc”. The term “CD-ROM” is an abbreviation for “compact disc read-only memory”. The program may be stored in the storage of the server and transferred from the server to other computers to distribute the program. The program may be provided as a program product.

The computer temporarily stores the program stored in the portable medium or the program transferred from the server in the main storage device, for example. Then, the computer causes the processor to read the program stored in the main storage device, and causes the processor to perform processes according to the read program. The computer may read the program directly from the portable medium and perform processes according to the program. The computer may perform the processes according to the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “data equivalent to a program”.

A part or all of the functions of the pre-driving test device 20 may be realized by a programmable circuit or a dedicated circuit as the control unit 21. That is, a part or all of the functions of the pre-driving test device 20 may be realized by hardware.

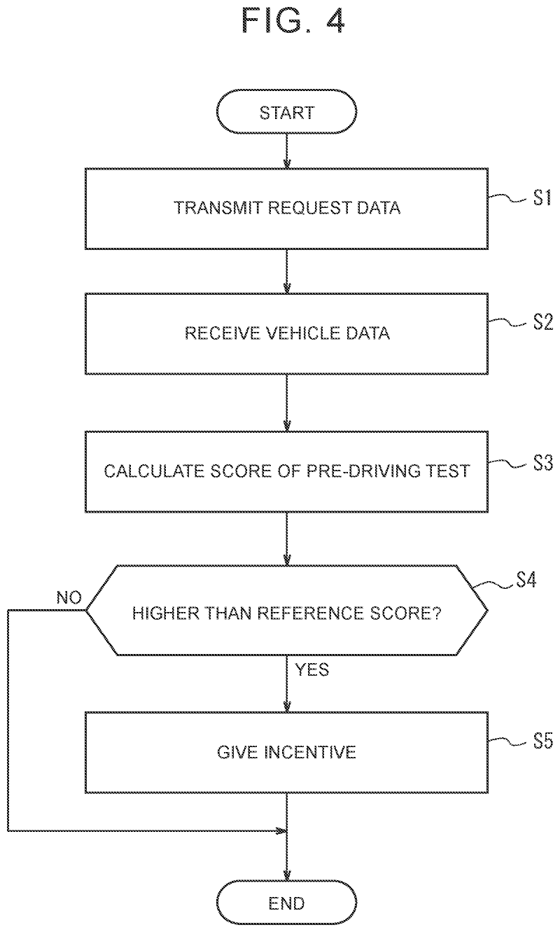

The operation of the pre-driving test device 20 according to the present embodiment will be described with reference to FIG. 4. The operation corresponds to a pre-driving test implementation method according to the present embodiment.

The processes in steps S1 and S2 are executed after the vehicle 30 is started and before the vehicle 30 starts moving. That is, the processes in steps S1 and S2 are executed while the vehicle 30 is stopped after the power source such as the engine or the motor of the vehicle 30 is started.

When the power source is started, the vehicle 30 transmits first notification data D3 to the pre-driving test device 20 via an interface corresponding to a mobile communication standard such as LTE, the 4G standard, or the 5G standard. The term “LTE” is an abbreviation for “long term evolution”. The term “4G” is an abbreviation for “fourth generation”. The term “5G” is an abbreviation for “fifth generation”. The first notification data D3 is data for notifying that the power source of the vehicle 30 has started.

In step S1, the communication unit 23 of the pre-driving test device 20 receives the first notification data D3 from the vehicle 30. When the first notification data D3 is received by the communication unit 23, the control unit 21 of the pre-driving test device 20 outputs the request data D1 to the communication unit 23. The request data D1 is data that requests the user 11 for performing the user operation as a pre-driving test. The user operation includes a steering wheel operation, an accelerator operation, and a brake operation in the present embodiment. The communication unit 23 transmits the request data D1 to the vehicle 30.

The vehicle 30 receives the request data D1 from the pre-driving test device 20 via an interface conforming to the mobile communication standard. The vehicle 30 presents the received request data D1 to the user 11. As a method of presenting the request data D1 to the user 11, any method may be used. However, in the present embodiment, a method of displaying the content of the request data D1 on an on-board display, a method of outputting the content of the request data D1 by voice from an on-board speaker, or both of these are used. The on-board display is, for example, an LCD or an organic EL display. The term “LCD” is an abbreviation for “liquid crystal display”. The term “EL” is an abbreviation for “electroluminescence”.

The user 11 receives various instructions such as when, how much, and in which direction the steering wheel of the vehicle 30 is rotated, when and how much to depress an accelerator pedal of the vehicle 30, and when and how much to depress the brake pedal of the vehicle 30. These instructions are represented by characters, symbols, graphics, or images displayed on the on-board display, voice output from the on-board speaker, or both. The pre-driving test device 20 or the vehicle 30 may issue various instructions to the user 11 in cooperation with an application running on a mobile device such as a mobile phone, a smartphone, or a tablet of the user 11.

When the user operation is performed, the vehicle 30 transmits the vehicle data D2 to the pre-driving test device 20 via the interface conforming to the mobile communication standard. The vehicle data D2 is data recorded by the vehicle 30 while the user operation is being performed. In the present embodiment, the vehicle data D2 includes time-series data indicating a rotation angle of the steering wheel of the vehicle 30 for each time as data recorded by the vehicle 30 when the steering wheel operation is being performed. The vehicle data D2 includes time-series data indicating the pedal position of the accelerator pedal of the vehicle 30 for each time as data recorded by the vehicle 30 when the accelerator operation is being performed. The vehicle data D2 includes time-series data indicating the pedal position of the brake pedal of the vehicle 30 for each time as data recorded by the vehicle 30 when the brake operation is being performed.

In step S2, the communication unit 23 of the pre-driving test device 20 receives the vehicle data D2 from the vehicle 30. The control unit 21 of the pre-driving test device 20 acquires the vehicle data D2 received by the communication unit 23. The control unit 21 stores the acquired vehicle data D2 in the storage unit 22.

The processes in steps S3 to S5 may be executed after the start of movement of the vehicle 30. However, in the present embodiment, the processes are executed after the vehicle 30 is started and before the vehicle 30 starts moving, as the processes of steps S1 and S2. That is, the processes in steps S3 to S5 may be executed while the vehicle 30 is moving. However, in the present embodiment, the processes are executed while the vehicle 30 is stopped.

In step S3, the control unit 21 of the pre-driving test device 20 calculates the score of the pre-driving test by evaluating the user operation based on the vehicle data D2 stored in the storage unit 22. In the present embodiment, the control unit 21 analyzes the time-series data indicating the rotation angle of the steering wheel of the vehicle 30 for each time and evaluates the steering wheel operation. The control unit 21 analyzes the time-series data indicating the pedal position of the accelerator pedal of the vehicle 30 for each time and evaluates the accelerator operation. The control unit 21 analyzes the time-series data indicating the pedal position of the brake pedal of the vehicle 30 for each time and evaluates the brake operation. Specifically, the control unit 21 determines whether the user 11 has been able to rotate the steering wheel in a designated direction by a designated angle at a designated timing. The control unit 21 determines whether the user 11 has been able to depress the accelerator pedal by a designated amount at a designated timing. The control unit 21 determines whether the user 11 has been able to depress the brake pedal by a designated amount at a designated timing. The control unit 21 may subtract the score corresponding to the number of seconds delayed in the steering wheel operation from the score of the pre-driving test. The control unit 21 may subtract the score corresponding to the seconds delayed in the accelerator operation from the score of the pre-driving test. The control unit 21 may subtract the score corresponding to the number of seconds delayed in the braking operation from the score of the pre-driving test. The control unit 21 stores the calculated score in the storage unit 22.

In step S4, the control unit 21 of the pre-driving test device 20 compares the score stored in the storage unit 22 with the reference score stored in the storage unit 22 in advance. The reference score may be a fixed value, but is a variable value in the present embodiment. The reference score is specifically the score of the previous pre-driving test. In the present embodiment, the score is stored in the storage unit 22 each time the pre-driving test is implemented.

When the score calculated in step S3 is higher than the reference score, that is, when the score of the pre-driving test is improved from the previous time, the process in step S5 is executed. When the score calculated in step S3 is equal to or less than the reference score, that is, when the score of the pre-driving test is the same as or lower than the previous time, the flow shown in FIG. 4 ends.

In step S5, the control unit 21 of the pre-driving test device 20 determines to give an incentive to the user 11. Specifically, the control unit 21 executes a process of giving an incentive to the user 11, such as a process of increasing reward points recorded in the database in association with the user 11, or a process of transferring a preset amount from the bank account that the user 11 always uses to a dedicated account.

As a modification of the present embodiment, the control unit 21 of the pre-driving test device 20 may transmit second notification data D4 to the communication unit 23. The second notification data D4 is data for notifying the user 11 to give an incentive. The second notification data D4 may include data for notifying the score calculated in step S3. The second notification data D4 may further include data for notifying the reference score.

In this modification, the vehicle 30 receives the second notification data D4 from the pre-driving test device 20. The vehicle 30 presents the received second notification data D4 to the user 11. As a method of presenting the second notification data D4 to the user 11, any method may be used. However, in this modification, a method of displaying the content of the second notification data D4 on the on-board display, a method of outputting the content of the second notification data D4 by voice from the on-board speaker, or both of these are used.

The present disclosure is not limited to the embodiments described above. For example, two or more blocks shown in the block diagram may be integrated, or a single block may be divided. Instead of executing two or more steps shown in the flowcharts in chronological order according to the description, the steps may be executed in parallel or in a different order, depending on the processing capacities of the devices that execute the steps, or as necessary. Other changes may be made without departing from the scope of the present disclosure.

For example, the incentive may vary depending on the score of the pre-driving test, for example, as the difference between the score calculated in step S3 and the reference score becomes larger, the incentive is increased. The incentive may vary depending on the seconds delayed in the user operation, for example, as the seconds delayed in the steering wheel operation, the accelerator operation, or the brake operation become shorter, the incentive is increased. The incentive may vary depending on whether the pedal is depressed correctly, for example, the incentive is increased when there is no mistake in pedaling.

For example, the pre-driving test device 20 may be provided in the vehicle 30. In this case, in step S1, the control unit 21 of the pre-driving test device 20 may output the request data D1 to the user 11 instead of outputting the request data D1 to the communication unit 23. That is, the pre-driving test device 20 may directly present the request data D1 to the user 11 instead of transmitting the request data D1 to the vehicle 30 and presenting the request data D1 to the user 11.

What is claimed is:

1. A pre-driving test device comprising a control unit that calculates a score of a pre-driving test by outputting request data that requests a user for performing a user operation including, as the pre-driving test, a steering wheel operation, an accelerator operation, a brake operation, or an arbitrary combination of the steering wheel operation, the accelerator operation, and the brake operation, after a vehicle is started and before the vehicle starts moving, acquiring vehicle data recorded in the vehicle while the user operation is being performed, and evaluating the user operation based on the vehicle data acquired, and determines whether to give an incentive to the user by comparing the calculated score with a reference score.
